(19) United States
(12) Patent Application Publication
(10) Pub. No.: US 2023/0271384 A1
(43) Pub. Date: Aug. 31, 2023

(54) LIGHT SOURCE ASSEMBLY AND PRINTER

(71) Applicant: Shenzhen Anycubic Technology Co., Ltd., Shenzhen (CN)

(72) Inventor: Xinqiao DENG, Shenzhen (CN)

(73) Assignee: Shenzhen Anycubic Technology Co., Ltd., Shenzhen (CN)

(21) Appl. No.: 18/131,371

(22) Filed: Apr. 6, 2023

Related U.S. Application Data
(63) Continuation of application No. PCT/CN2022/105683, filed on Jul. 14, 2022.

(30) Foreign Application Priority Data
Jun. 25, 2021 (CN) 202110709542.6
Apr. 27, 2022 (CN) 202210453658.2

(51) Int. Cl. B29C 64/264; B33Y 30/00; G02B 3/04; G02B 27/30

(52) U.S. Cl. CPC B29C 64/264; B33Y 30/00; G02B 3/04; G02B 27/30

(57) ABSTRACT

A light source assembly and a printer reduce the loss of light rays, increase the utilization rate of the light rays and avoid the non-uniform light projection while uniformizing and collimating the light rays mainly by means of the cooperation of a lens and a reflector, thereby facilitating uniform curing of a printing resin. The main technical solution is as follows: a light source assembly for a printer, the light source assembly including a light-emitting element, a lens and a reflector. The light-emitting element and the reflector are arranged on two opposite sides of the lens. The reflector cooperates with the lens such that light rays emitted by the light-emitting element are projected after being refracted by the lens and reflected by the reflector. The light source assembly is primarily used for 3D printing.

### CROSS REFERENCE TO THE RELATED APPLICATIONS

This application is the continuation application of International Application No. PCT/CN2022/105683, filed on Jul. 14, 2022, which is based upon and claims priority to Chinese Patent Applications No. 202110709542.6, filed on Jun. 25, 2021, and No. 202210453658.2, filed on Apr. 27, 2022, the entire contents of which are incorporated herein by reference.

### TECHNICAL FIELD

The present invention relates to the technical field of 3D printing, and in particular to a light source assembly and a printer.

### BACKGROUND

In the related art, in order to ensure the printing accuracy of a photo-curing printer, it is necessary to keep light rays emitted to a screen as parallel as possible.

At present, in order to ensure the uniformity of the light rays emitted to the screen, a light source selected for the photo-curing printer is generally a funnel-shaped light source. However, since the light rays emitted from the funnel-shaped light source are dispersed in angle, it is difficult to perpendicularly project the light rays emitted from the funnel-shaped light source toward the screen, and the printing accuracy of the photo-curing printer is thus affected.

It can be seen that in the related art, there is a problem of poor perpendicularity of the light rays projected into the screen.

### SUMMARY

In view of this, the present invention provides a light source assembly and a printer, which reduce the loss of light rays, increase the utilization rate of the light rays and avoid the non-uniform light projection while uniformizing and collimating the light rays mainly by means of the cooperation of a lens and a reflector, thereby facilitating uniform curing of a printing resin.

In order to achieve the above objective, the present invention mainly provides the following technical solutions.

In an aspect, the present invention provides a light source assembly for a printer, the light source assembly including:

a light-emitting element, a lens, and a reflector.

The light-emitting element and the reflector are arranged on two opposite sides of the lens; and

the reflector cooperates with the lens such that light rays emitted by the light-emitting element are projected after being refracted by the lens and reflected by the reflector.

The lens includes a convex surface and a bottom surface facing away from each other, the reflector includes a concave curved surface, the light-emitting element is arranged corresponding to the bottom surface, and the concave curved surface is arranged corresponding to the convex surface.

In a further aspect, an embodiment of the present application provides a printer, including a base, a light source assembly, an optical refractor and a screen. The light source assembly and the optical refractor are both arranged on the base, and the light source assembly and the screen are both arranged corresponding to the optical refractor.

A refracting surface of the optical refractor is a concave curved surface, the light source assembly includes a light-emitting element and a lens that are integrally provided, after passing through the lens, light rays emitted by the light-emitting element are converted into light rays with a fixed emission angle and uniform energy, and the light rays passing through the lens are emitted to the optical refractor, are refracted by the optical refractor, and are then perpendicularly projected into the screen.

In the embodiment of the present application, by using the light source assembly including the light-emitting element and the lens that are integrally provided, the light source assembly can emit the light rays fixed in emission angle and uniform in energy, and the light rays emitted by the light source assembly can be converted into the light rays perpendicularly projected into the screen after being refracted by the refracting surface that is the concave curved surface, namely, the light rays emitted by the light source assembly can be perpendicularly projected into the screen, and thus the purpose of improving the perpendicularity of the light rays projected into the screen is achieved. The loss of the light ways is reduced, the utilization rate of the light ways is increased and the non-uniform light projection is avoided while the light rays are uniformized and collimated mainly by means of the cooperation of the lens and the reflector, thereby facilitating uniform curing of a printing resin. In the prior art, since a beam includes light rays at various angles, in order to ensure that collimated light rays are perpendicular to the screen as much as possible, stray light in the light rays is filtered first, and the filtered light rays are then collimated, so that part of the light rays are intercepted and cannot be projected, leading to reduction in the intensity of the projected light, and the uniformity of the projected light cannot be ensured, affecting the effect of curing the printing resin. Compared with the prior art, in the present application, the light rays emitted by a light-emitting element are uniformized by the lens and then projected into the reflector, and the reflector adjusts the angles of the light rays by reflecting the light rays, so that the propagation angle range of the light rays becomes small, and the collimation of the light rays is achieved; and the light rays are collimated by means of reflection without the loss of light rays, so that the intensity and the uniformity of the transmitted light are ensured.

### BRIEF DESCRIPTION OF THE DRAWINGS

FIG. 1 is a first schematic structural diagram of a printer provided in an embodiment of the present application;

FIG. 2 is a second schematic structural diagram of a printer provided in an embodiment of the present application;

FIG. 3 is a first schematic structural diagram of an optical reflector provided in an embodiment of the present application;

FIG. 4 is a second schematic structural diagram of an optical reflector provided in an embodiment of the present application;

FIG. 5 is a schematic exploded view of a light source assembly provided in an embodiment of the present application;

FIG. 6 is a schematic structural diagram of a light source assembly provided in an embodiment of the present invention;

FIG. 7 is a schematic diagram illustrating the angles and positions of constituent structures of a light source assembly provided in an embodiment of the present invention;

FIG. 8 is a schematic perspective structural diagram of a reflector provided in an embodiment of the present invention;

FIG. 9 is a side view of the reflector shown in FIG. 8 in an x direction;

FIG. 10 is a side view of the reflector shown in FIG. 8 in a y direction;

FIG. 11 is a top view of the reflector shown in FIG. 8 in a z direction;

FIG. 12 is a schematic structural diagram of a light-emitting element and a lens provided in an embodiment of the present invention;

FIG. 13 is another schematic structural diagram of a light-emitting element and a lens provided in an embodiment of the present invention; and

FIG. 14 is still another schematic structural diagram of a light-emitting element and a lens provided in an embodiment of the present invention.

### DETAILED DESCRIPTION OF THE EMBODIMENTS

Embodiments of the present application will be described below in detail, and examples of the embodiments are shown in the drawings, wherein the same or similar reference numerals represent the same or similar elements or elements having the same or similar functions throughout. The embodiments described below with reference to the accompanying drawings are exemplary and are merely intended to be illustrative of the present application, and will not be interpreted as limiting the present application. The following embodiments and features of the embodiments can be combined with each other without conflict. All the other embodiments obtained by those of ordinary skill in the art based on the embodiments of the present application without creative efforts shall fall within the scope of protection of the present application.

The features defined by the terms “first”, “second”, etc. in the specification and the claims of the present application can explicitly or implicitly include one or more of the features. In the description of the present application, the term “a plurality of” means two or more, unless otherwise specified. In addition, “and/or” in the specification and the claims indicates at least one of connected objects, and the character “/” generally indicates an “or” relationship between associated objects.

In the description of the present application, it should be noted that unless otherwise explicitly specified and defined, terms “mounting”, “connecting” and “connection” should be understood in a broad sense, for example, they can be a fixed connection, a detachable connection, or an integrated connection, can be a mechanical connection or an electrical connection; or can be a direct connection, an indirect connection by means of an intermediate medium, or internal communication between two elements. For those of ordinary skills in the art, the specific meaning of the terms mentioned above in the present application can be understood according to specific circumstances.

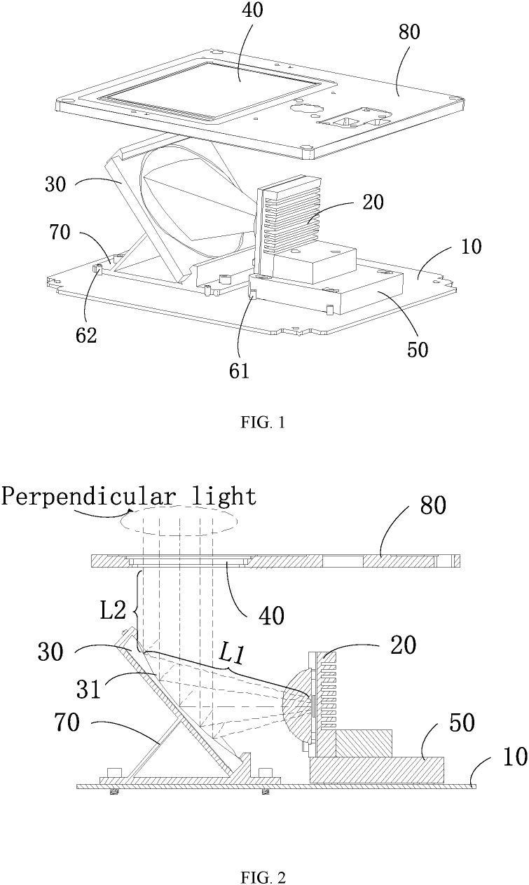

As shown in FIGS. 1-5, an embodiment of the present application provides a printer. The printer can be a photo-curing printer, and the printer includes a base 10, a light source assembly 20, an optical refractor 30 and a screen 40. The light source assembly 20 and the optical refractor 30 are both arranged on the base 10, and the light source assembly 20 and the screen 40 are both arranged corresponding to the optical refractor 30.

A refracting surface of the optical refractor 30 is a concave curved surface 31, and the light source assembly 20 includes a light-emitting element 21 and a lens 22 that are integrally provided. After passing through the lens 22, light rays emitted by the light-emitting element 21 are converted into light rays with fixed angles and uniform energy, and the light rays passing through the lens 22 are emitted the optical refractor 30, are refracted by the optical refractor 30, and are then perpendicularly projected into the screen 40.

In the embodiment, by using the light source assembly 20 including the light-emitting element 21 and the lens 22 that are integrally provided, the light source assembly 20 can emit the light rays with a fixed emission angle and uniform energy, and the light rays emitted from the light source assembly 20 can be converted into the light rays perpendicularly projected into the screen 40 after being refracted by the refracting surface that is the concave curved surface 31, namely, the light rays emitted by the light source assembly 20 can be perpendicularly projected into the screen 40, and thus the purpose of improving the perpendicularity of the light rays projected into the screen 40 is achieved.

In addition, since the light rays emitted by the light source assembly 20 also have the characteristic of energy uniformity, the problem of energy deviation of the light rays projected into the screen 40 is improved, and the purpose of improving the printing accuracy and the printing effect of the printer is achieved.

It will be appreciated that the screen 40 can be an LCD screen and be used for transmitting light and displaying images to be printed.

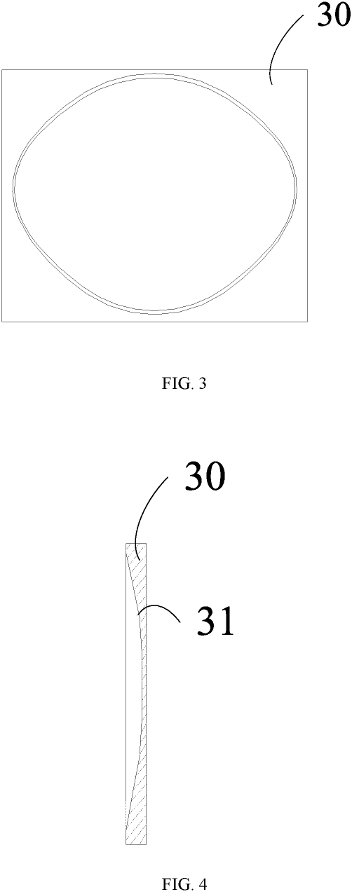

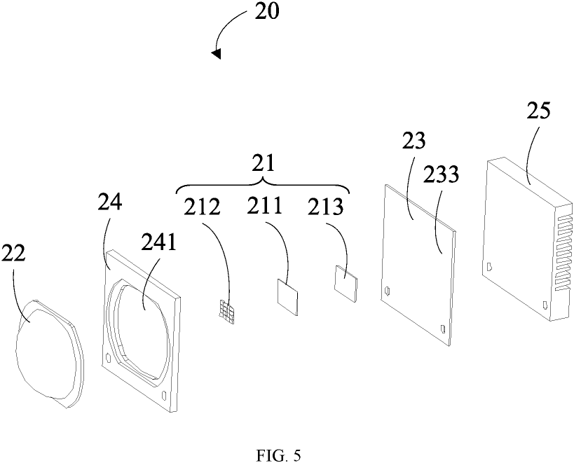

As shown in FIGS. 3 and 4, the concave curved surface 31 of the optical refractor 30 can be a concave spherical surface or a concave ellipsoidal surface, and a concave parameter thereof is associated with an optical parameter of the lens 22, namely, the concave parameter of the concave curved surface 31 can be set according to the optical parameter of the lens 22.

As shown in FIG. 2, the light rays emitted through the lens 22 are defined as A-type light rays, namely, the light rays emitted by the light-emitting element 21 can be converted into the A-type light rays after passing through the lens 22, that is to say, converted into the light rays with a fixed emission angle and uniform energy; and the light rays refracted by the optical refractor 30 are defined as B-type light ray, namely, the A-type light rays can be converted into the B-type light rays after being refracted by the optical refractor 30, that is to say, converted into the light rays perpendicularly projected into the screen 40, and thus the purpose of improving the perpendicularity of the light rays projected into the screen 40 is achieved.

The printing area of the screen 40 is determined by an illumination range of the light source assembly 20 on the screen 40, and the farther the distance from the light source assembly 20 to the screen 40 is, the greater the illumination range of the light source assembly 20 on the screen 40 is. For example, when the printing area of the screen 40 is set to S, namely, when the illumination range of the light source assembly 20 on the screen 40 is set to S, it is necessary to set the distance between the light source assembly 20 and the screen 40 to L in order to meet the printing requirements of the printer.

In the present application, since the light rays emitted by the light source assembly 20 need to be refracted by the optical refractor 30, a transmission path of the light rays between the light source assembly 20 and the screen 40 is divided into two segments, namely, a pre-refraction transmission path segment and a post-refraction transmission path segment. That is to say, the light rays emitted by the light source assembly 20 are classified into the A-type light rays and the B-type light rays, and the sum of the transmission path length of the A-type light rays and the transmission path length of the B-type light rays needs to be equal to L, in order to meet the printing requirements of the printer.

As shown in FIG. 2, the length of outlines of the A-type light rays is represented by L1, and the length of outlines of the B-type light rays is represented by L2, so that the sum of L1 and L2 needs to be equal to L, in order to meet the printing requirements of the printer.

In addition, the values of L1 and L2 can also be flexibly set according to the dimension requirements of the printer to meet the actual design requirements. For example, when a low printer is needed, the value of L2 can be decreased to decrease the height of the printer.

In the process of producing the optical refractor 30, a plate can be provided first, the concave curved surface 31 is then formed on the plate, and an optical reflective layer is finally provided on the concave curved surface 31 to obtain the optical refractor. The optical reflective layer can be deposited on the concave curved surface 31 by means of electroplating.

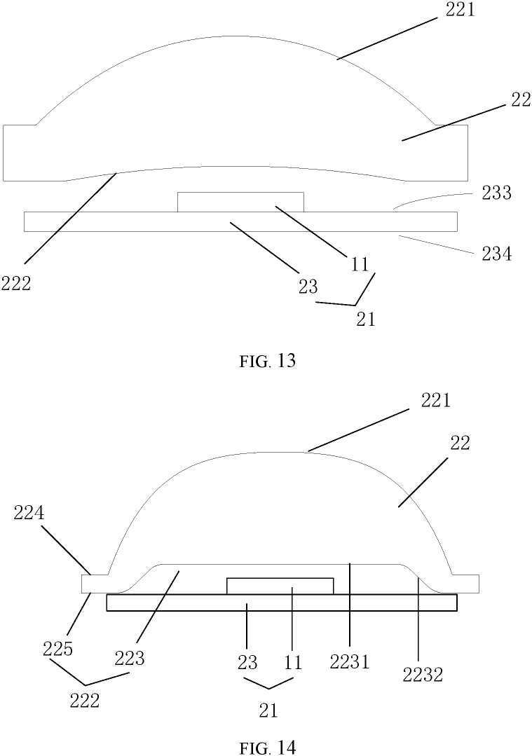

Optionally, as shown in FIGS. 5 and 13, the light source assembly 20 further includes a substrate 23 and a lens holder 24. The substrate 23 includes a first surface 233 and a second surface 234 that are arranged facing away from each other.

The lens 22 is arranged on the first surface 233 by means of the lens holder 24, and the light-emitting element 21 is arranged on the first surface 233 and is located between the lens 22 and the first surface 233.

In an embodiment, the lens holder 24 can cover the first surface 233, a receiving cavity 241 can be formed between the lens holder 24 and the first surface 233, and the light-emitting element 21 can be located in the receiving cavity 241 so as to achieve the integrated arrangement of the light-emitting element 21 and the lens 22.

In an example, the lens holder 24 is made of a light-shielding material, or an inner surface or an outer surface of the lens holder 24 is provided with a light-shielding layer, so as to prevent the light rays emitted by the light-emitting element 21 from being emitted in other directions than in the direction of the lens 22, and to achieve the purpose of improving the light emission effect of the light source assembly 20.

Optionally, the light-emitting element 21 includes a chip substrate 211 and a light-emitting chip 212. The light-emitting chip 212 is arranged on the first surface 233 by means of the chip substrate 211, and after passing through the lens 22, the light rays emitted by the light-emitting chip 212 are converted into light rays with a fixed emission angle and uniform energy.

In an embodiment, the light-emitting chip 212 can be a matrix light source chip, such as a COB light source chip, such that the light rays emitted by the light-emitting element 21 have the characteristics of a fixed emission angle and uniform energy.

It will be appreciated that the light rays emitted by the light source assembly 20 in the present application can be ultraviolet light rays.

Furthermore, the light-emitting element 21 can further include a chip base 213. The light-emitting chip 212 is arranged on a chip substrate 211, the chip substrate 211 is arranged on the chip base 213, and the chip base 213 is arranged on the first surface 233.

Moreover, the light source assembly 20 can further include a heat sink 25. The heat sink 25 is arranged on the second surface 234, and the heat sink 25 is used for reducing the temperature at the light-emitting element 21 and avoiding the overheating problem of the light-emitting element 21.

Optionally, the printer further includes a carriage 50. The light source assembly 20 is connected to the base 10 via the carriage 50, and the carriage 50 is slidably connected to the base 10.

In the embodiment, by providing the carriage 50, the distance between the light source assembly 20 and the optical refractor 30 can be adjusted, and the coverage area of the optical refractor 30 for the screen 40, namely, the printing area of the printer, can thus be adjusted.

For example, the farther the light source assembly 20 is from the optical refractor 30, the larger the coverage area of the optical refractor 30 for the screen 40, namely, the larger the printing area of the printer; the closer the light source assembly 20 is to the optical refractor 30, the smaller the coverage area of the optical refractor 30 for the screen 40, namely, the smaller the printing area of the printer; and flexible adjustment of the printing area of the printer is thus achieved.

Optionally, the printer further includes a first limiting post 61, a first limiting hole (not shown) adapted to the first limiting post 61 is formed in the base 10, and the first limiting post 61 is assembled in the first limiting hole.

The carriage 50 is movable relative to the base 10 along the first limiting post 61.

In the embodiment, by providing the first limiting post 61, it is possible to prevent offsetting of the carriage 50 during movement, namely, the movement accuracy of the light source assembly 20, thereby achieving the purpose of accelerating printing of the printer.

Optionally, the printer further includes a fixing seat 70, and the optical refractor 30 is arranged on the base 10 by means of the fixing seat 70.

The fixing seat 70 is detachably connected to the base 10, and the optical refractor 30 is in a snap connection with the fixing seat 70.

In the embodiment, the connection stability of the optical refractor 30 and the base 10 can be improved by arranging the optical refractor 30 on the base 10 via the fixing seat 70.

The fixing seat 70 and the base 10 can be fixedly connected to each other by means of a bolt; and a snap-in strip (not shown) can be arranged on the optical refractor 30, a groove (not shown) adapted to the snap-in strip can be provided in the fixing seat 70, and the optical refractor 30 is fixed to the fixing seat 70 by means of snap-fitting of the snap-in strip and the groove.

Optionally, the printer further includes a second limiting post 62, a second limiting hole (not shown) adapted to the second limiting post 62 is formed in the base 10, the second limiting post 62 is assembled in the second limiting hole, and the second limiting post 62 is used for limiting the mounting position of the fixing seat 70 on the base 10.

In the embodiment, by providing the second limiting post 62, it is possible to improve the mounting accuracy of the fixing seat 70 on the base 10 and to improve the refractive effect of the optical refractor 30.

Optionally, the printer further includes a fixing plate 80, and the screen 40 is arranged on the fixing plate 80.

The printer further includes a main body (not shown). The base 10 and the fixing plate 80 are both arranged on the main body.

Optionally, as shown in FIG. 1, the light source assembly 20 and the optical refractor 30 are located between the base 10 and the screen 40, a forward projection of the optical refractor 30 on a first planar surface at least partially overlaps with a forward projection of the screen 40 on the first planar surface, and a forward projection of the light source assembly 20 on the first planar surface is spaced apart from the forward projection of the screen 40 on the first planar surface.

The first planar surface is the plane where a bearing surface of the base 10 is located.

In the embodiment, by arranging the light source assembly 20, the optical refractor 30 and the screen 40 non-coaxially, namely, arranging the light source assembly 20, the optical refractor 30 and the screen 40 in a misaligned manner, particularly arranging the light source assembly 20 and the screen 40 in a misaligned manner, the linear distance between the light source assembly 20 and the screen 40 can be shortened, and the overall height of the printer is thus decreased, conforming to the development trend of miniaturization of the printer.

In an example, the light source assembly 20 and the optical refractor 30 can be both arranged on the bearing surface of the base 10.

As shown in FIG. 2, the optical refractor 30 can be arranged directly below the screen, and the light source assembly 20 can be arranged directly in front of the refracting surface of the optical refractor 30, so as to divide an optical transmission path between the light source assembly 20 and the screen 40 into two segments, namely, a pre-refraction transmission path segment L1 and a post-refraction transmission path segment L2, and to make the sum value of L1 and L2 equal to the linear distance between the light source assembly 20 and the screen 40, thereby decreasing the overall height of the printer and conforming to the development trend of miniaturization of the printer.

Moreover, with such an arrangement, it is possible to increase the coverage area of the optical refractor 30 for the screen 40, and thus the printing area of the printer is increased.

In the description of the specification, the description with reference to terms such as “an embodiment”, “some embodiments”, “a schematic embodiment”, “an example”, “a specific example”, or “some examples” means that specific features, structures, materials, or characteristics described in combination with the embodiments or examples are included in at least one embodiment or example of the present application. In this specification, the schematic expressions of the above terms do not necessarily refer to the same embodiments or examples. Moreover, the specific features, structures, materials, or characteristics described herein can be combined in any one or more embodiments or examples in a suitable manner.

Although the embodiments of the present application have been shown and described, those of ordinary skill in the art can understand that various changes, modifications, substitutions, and variations can be made to these embodiments without departing from the principles and spirit of the present application. The scope of the present application is defined by the claims and equivalents thereof.

Those skilled in the art would have clearly understood that for convenience and conciseness of description, the specific working processes of the above-described systems, devices and units can refer to the corresponding processes in the above-described embodiments of the method and will not be further described herein.

In several embodiments provided in the disclosure, it should be understood that the disclosed systems, devices and methods can be implemented in other ways. For example, the device embodiments described above are merely exemplary. For example, the division of units is only a logic function division. In actual implementation, there can be other division methods, for example, multiple units or components can be combined or integrated into another system, or some features can be omitted or not implemented. In addition, the mutual coupling or direct coupling or communication connection shown or discussed can be indirect coupling or communication connection through some interfaces, apparatuses or units, and can be in electrical, mechanical or other forms.

The units described as separate parts is physically separated or is not physically separated, and the parts displayed as units may or may not be physical units, that is, may be located in one place, or may be distributed over multiple network units. Some or all of the units can be selected according to actual needs to achieve the objectives of solutions of the embodiments.

Additionally, the functional units in the embodiments of the present application may be integrated into one processing unit or may also exist as being physically separate, or two or more of the units may be integrated into one unit. The above-mentioned integrated units may be implemented in the form of hardware or in the form of software functional units.

If the integrated unit is implemented in the form of the software function unit and sold or used as an independent product, it may be stored in a computer-readable storage medium. Based on such an understanding, the technical solution of the present application essentially, or a part contributing to the prior art, or all or part of the technical solution may be embodied in the form of a software product. The computer software product is stored in a storage medium and includes several instructions to cause a computer device (which may be a personal computer, a server, a network device, etc.) to execute all or some steps of the method described in the embodiments of the present application. The foregoing storage medium includes: a USB flash disk, a removable hard disk, a read-only memory (ROM), a random access memory (RAM), a magnetic disk or an optical disk and other media that can store program codes.

In order to further illustrate the technical means used to achieve the intended purpose of the present application and the technical effects of the present application, specific implementations, the structure, features and effects of a light source assembly provided according to the present invention are described in detail below in conjunction with the accompanying drawings and preferred embodiments. For ease of description, light emitted by the light source assembly is described in the form of light rays.

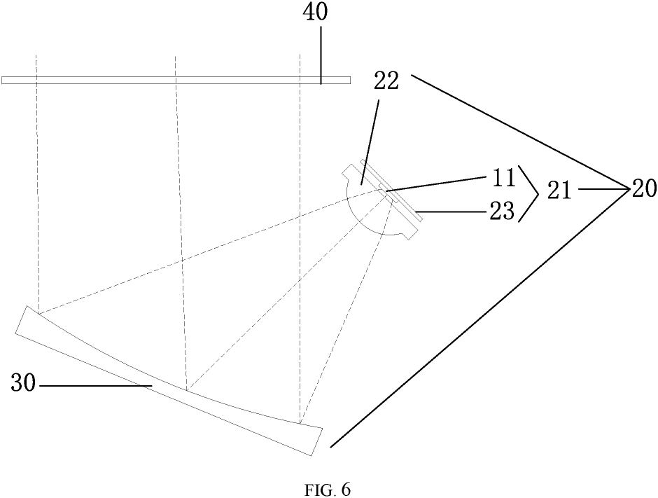

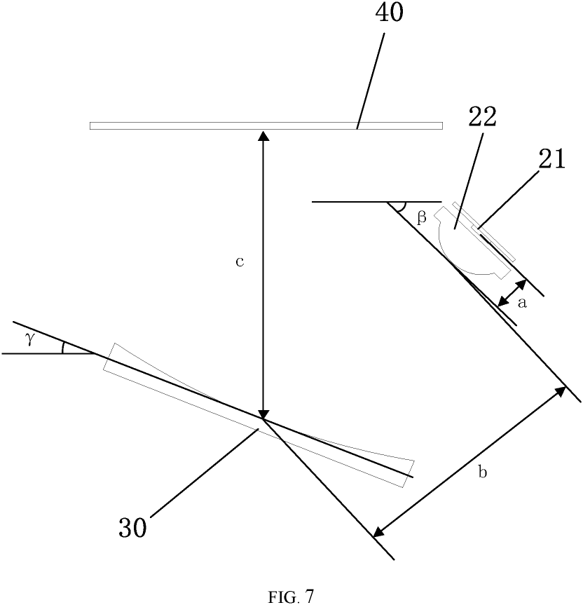

In an aspect, as shown in FIGS. 6-7, an embodiment of the present invention provides a light source assembly 20 for a printer, the light source assembly including:

a light-emitting element 21, a lens 22 and a reflector 30.

The light-emitting element 21 and the reflector 30 are arranged on two opposite sides of the lens 22; and

the reflector 30 cooperates with the lens 22 such that light rays emitted by the light-emitting element 21 are projected after being refracted by the lens 22 and reflected by the reflector 30.

In an embodiment, the printer includes a base case of a cavity structure. A screen 40 is provided on the base case. In some embodiments, the screen 40 refers to a screen integrated with no backlight module, and may include liquid crystal, and two polarizers or two polarizing films, so that light is selectively allowed or not allowed to pass through under the optical rotation action of the liquid crystal in the screen, and a function of switching on/off a light channel is provided. When the liquid crystal in the screen is controlled to be not light-transmissive, the light channel is closed; and when the liquid crystal therein is controlled to be light-transmissive, the light channel is opened. The light source assembly 20 is located in the base case, and a resin vat is provided on the side of the screen 40 facing away from the light source assembly 20. Slicing data of a printing model is transmitted to the screen 40 one by one by a master controller, the screen 40 allows light rays of a specific contour to pass through, and the light rays emitted by the light source assembly 20 are projected into the screen 40, pass through the screen 40, and are then projected into a printing resin in the resin vat in the form of the specific contour, so that the printing resin is cured according to the specific contour. For ease of description, a light projection manner in which the screen 40 is located at the top end of the base case and the light source assembly 20 performs projection from bottom to top is taken as an example. In addition, it is also possible that the screen 40 is located at the bottom end of the base case, and the light source assembly 20 performs projection from top to bottom.

The light-emitting element 21 can be in various forms, such as a chip on board (COB) light source, an integrated light source, a laser light source or a mercury lamp. The light-emitting element 21 includes a light source 11 and a substrate 23. The light source 11 may be a point light source or a surface light source with a distance between light-emitting chips being less than a threshold, such as a threshold of 3 mm. The distance can refer to the distance from an edge of one light-emitting chip to an edge of another light-emitting chip. The light source 11 is an integrated light source or a COB light source with a distance between light-emitting chips being less than or equal to 3 mm. In this embodiment, as an example, the light source 11 is a point light source or a surface light source with a very small distance between the light-emitting chips, for example, the light-emitting element 21 emits light by means of a UV lamp bead or a plurality of light-emitting chips with a very small distance therebetween. The light rays from the light-emitting element 21 propagate outwardly like a conical beam from the light-emitting chips. The lens 22 is arranged on the side of light ray propagation of the light-emitting element 21, and the light rays are refracted after passing through the lens 22, so that the propagation angles of the light rays are changed. For example, the light rays in the beam become more uniform. The light rays are refracted by the lens 22 and then projected onto the reflector 30, and the reflector 30 changes the angles of the light rays again by means of reflection, and collimated light rays are then projected into the screen 40. It can be understood that the density of the light rays of the beam emitted by the light source 11 gradually decreases from the central light rays to the external light rays, and the light intensity of light spots formed on a projection surface will gradually decrease from the center to the outside. In order to ensure the accuracy of resin formation and the uniformity of curing, the light rays are refracted by the lens 22, and the propagation angles of the light rays are adjusted. For example, the light rays close to the edge of the beam are gathered. The density of the light rays is then adjusted, so that the light rays propagate in the form of a uniform beam after passing through the lens 22. The reflector 30 is used for collimating the light rays so that the propagation angle range of the light rays in the beam becomes small, the light rays propagate approximately in the same direction, and the collimation degree of the projected light is then ensured. It should be noted that in the embodiment, since the refracted light rays are uniform light rays, and the reflector 30 has the effect of collimating the light rays, the refracted rays are reflected by the reflector 30 and then projected directly into the screen 40, thus ensuring the uniformity and collimation degree of the projected light rays. There is no need to add, for example, a collimating lens or a filter element between the reflector 30 and the screen 40 for re-processing the light rays, and the reflector 30 collimates the light rays by means of reflection. Compared with a method using a collimating lens or a filter element, the loss of the light rays can be reduced, reasonable utilization of the light rays can be ensured, and the effect of ensuring the intensity and the uniformity of the transmitted light is ensured.

The lens 22 and the reflector 30 can be adjusted according to different light source forms and projection accuracy requirements, in order to enable mutual cooperation of the lens 22 and the reflector 30 and to adjust the light rays to be a uniform beam propagating approximately in the same direction. In an embodiment, the lens 22 is a lens, the point light source is located on the central optical axis of the lens, and a central light ray of the beam propagates along the optical axis. That is, the central light ray does not change in direction after passing through the lens 22, while other light rays in the beam will be refracted after passing through the lens 22, and propagation paths of the light rays are adjusted so that the refracted light rays become uniform. For ease of description, a geometric central point of the reflector 30 is taken as a reflection point of the central light ray on the reflector 30, the light rays passing through the lens 22 are referred to as refracted light, the light rays reflected by the reflector 30 are referred to as reflected light, the reflected light is projected into the screen 40, and the reflected light is also referred to as projected light. In an embodiment, the beam still propagates in a beam form after passing through the lens 22, and reflection angles of reflection points corresponding to the light rays at different positions in the beam on the reflector 30 can be adjusted to achieve targeted adjustment on the angles of the reflected light rays. For example, the included angles between the reflected light rays of large-angle light rays and the reflected light ray of the central light ray become small, and thus the collimation of the light rays is achieved. In another embodiment, the reflector 30 can be configured to have the reflection angles gradually changed at points from the geometric central point to the periphery. For example, the reflecting surface of the reflector 30 is an arc-shaped concave curved surface 31, and the arc-shaped concave curved surface 31 plays a converging role on the transmitted light, so that the transmitted light in the beam form becomes collimated light.

In some embodiments, the primary function of the lens 22 is to refract the light, so the light reflection effect of the lens 22 is reduced as much as possible in design.

The uniformity of the light rays is determined by using a measuring instrument such as a radiation illuminometer to measure the radiation of a projection region on the screen 40 or a target surface, or to measure the light density or intensity of multiple points on the screen 40 or the target surface. In some embodiments, after the light rays emitted by the light-emitting element 21 are refracted by the lens 22, the radiations measured in the projection region of the screen 40 are the same or only have a slight difference, and it can be seen therefrom that the light rays emitted by the light-emitting element 21 are uniform light rays after being refracted by the lens 22. By changing the relative position of the screen 40 or the target surface and the reflector 30, whether the light rays are collimated can be determined by detecting a change of projection area. In some embodiments, the light rays emitted by the light-emitting element 21 are projected onto the reflector 30 after being refracted by the lens 22, and the reflector 30 reflects the light rays projected onto the reflecting surface and then projects them into the screen 40. A projection contour and the projection area are stable or change slightly during moving the screen 40, and it can be seen therefrom that the light rays form collimated light rays after being reflected by the reflector 30, and the collimated light rays are projected into the screen 40.

The above-mentioned small difference in the radiation and small changes in the projection contour and the projection area can be caused by lens processing errors or the external environment, and it can be understood that in the present application, the light rays projected into the screen 40 are mostly uniform and perpendicular light rays, and the utilization rate of the light rays is greatly increased without extensive loss of light rays.

The embodiments of the present invention provide a light source assembly 20 and a printer, which reduce the loss of light rays, increase the utilization rate of the light rays and avoid the non-uniform light projection while uniformizing and collimating the light rays mainly by means of the cooperation of a light-transmitting assembly and a reflector, thereby facilitating uniform curing of a printing resin. In the prior art, since the beam includes light rays at various angles, in order to ensure that the collimated light rays are aligned to a screen as much as possible, filter elements, such as some light shielding plates, filter stray light from the light rays, leading to reduction in the intensity of the projected light, and the uniformity of the projected light cannot be ensured, affecting the effect of curing the printing resin. Compared with the prior art, in the present application, the light rays emitted by the light-emitting element 21 are uniformized by the light-transmitting assembly and then projected onto the reflector, and the reflector adjusts the angles of the light rays by reflecting the light rays, so that the propagation angle range of the light rays becomes small, and the collimation of the light rays is achieved; and the light rays are collimated by means of reflection without the loss of light rays, so that the intensity and the uniformity of the transmitted light are ensured.

In the present application, the lens 22 and the reflector 30 can be in various forms, and an optimal combination can be obtained through experiments. For example, different reflection effects can be obtained by changing the structure of the reflecting surface of the reflector 30 and by adjusting an arrangement direction of the reflector 30, namely, different collimation effects are obtained. The present application provides several specific structures and parameters of the lens 22 and the reflector 30 for a specific form and an arrangement position of the point light source in this embodiment.

The lens 22 includes a convex surface 221 and a bottom surface 222 facing away from each other, the reflector 30 includes a concave curved surface 31, the light-emitting element 21 is arranged corresponding to the bottom surface 222, and the concave curved surface 31 is arranged corresponding to the convex surface 221. The light rays are refracted by the convex surface 221 and the bottom surface 222, and the light rays are reflected by the concave curved surface 31.

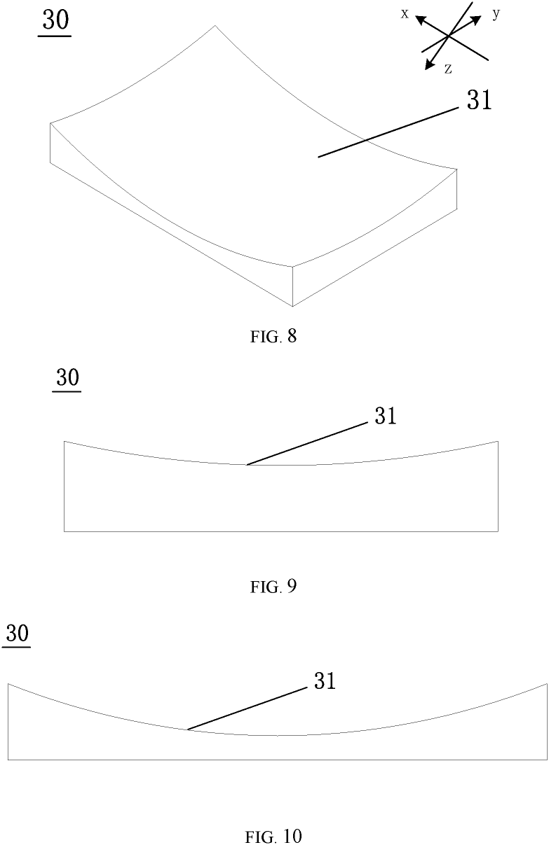

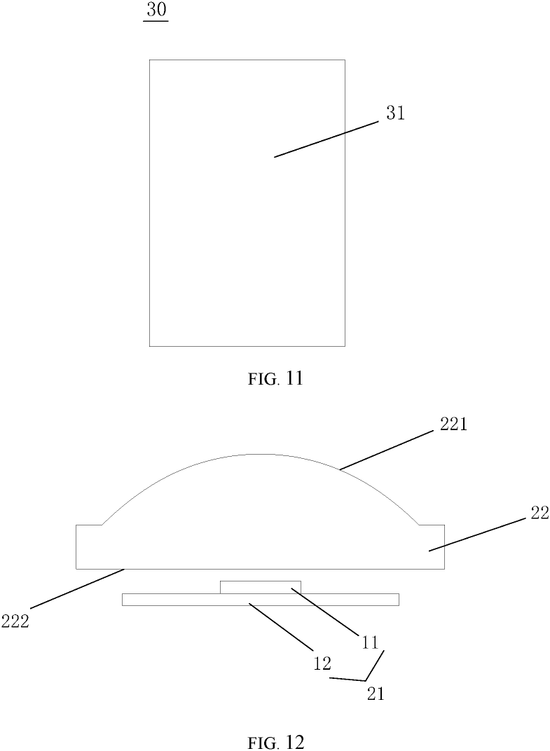

In an embodiment, as shown in FIGS. 8-10, the reflector 30 has an approximately plate-like structure with one surface being a planar surface and the other surface being a concave curved surface 31. The concave curved surface 31 is the reflecting surface of the reflector 30, the concave curved surface 31 can be a spherical surface or an aspherical surface, and the reflector 30 is arranged obliquely with the concave curved surface 31 facing the side of the screen 40 and the lens 22. Taking the lens 22 being a plano-convex lens, namely, the bottom surface 222 thereof being a planar surface, as an example, the plano-convex lens is located obliquely above the reflector 30 and is arranged obliquely, the convex surface 221 of the plano-convex lens corresponds to the concave curved surface 31 of the reflector 30, the light-emitting element 21 corresponds to the planar surface of the plano-convex lens, a light-emitting point of the light-emitting element 21 corresponds to the optical axis of the plano-convex lens, and the light rays form a uniform beam with a small divergence angle after being refracted by the plano-convex lens, and the beam is then condensed by means of the reflection of the reflector 30, so as to form collimated light.

In an embodiment, as shown in FIG. 7, an included angle β between a tangent plane of a vertex of the convex surface 221 and a horizontal plane is greater than or equal to 30° but less than 45°, such as 30°, 33°, 40°, or 44°. Alternatively, the included angle β between the tangent plane of the vertex of the convex surface 221 and the horizontal plane is greater than 45° but less than 90°, such as 48°, 55°, 60°, 75°, 84°, or 89°. Alternatively, the included angle β between the tangent plane of the vertex of the convex surface 221 and the horizontal plane is equal to 45°.

The vertex of the convex surface 221 can be understood as the geometric central point of the convex surface 221, and the vertex of the concave curved surface 31 can be understood as the geometric central point of the concave curved surface 31, namely, the center of the reflecting surface of the reflector 30. Taking the lens 22 being a plano-convex lens as an example, the vertex of the convex surface 221 is a point of intersection of the optical axis of the plano-convex lens and the convex surface 221. In an embodiment, the included angle β is greater than or equal to 30° but less than 45°, so that it is ensured that the light rays passing through the lens 22 propagate obliquely downwardly as mush as possible to avoid interference of the light rays of the light-emitting element 21 and the lens 22 with the screen 40. In another embodiment, the included angle β is greater than 45° but less than or equal to 90°, so that the light-emitting element 21 and the lens 22 can be located outside the light rays between the reflector 30 and the screen 40 to avoid the influence of the light-emitting element 21 and the lens 22 on the reflected light rays, and the light-emitting element 21 and the lens 22 can be located as close as possible to the bottom of the printer to avoid the interference of a large amount of heat generated by the light-emitting element 21 and the lens 22 on the screen.

In an embodiment, an included angle γ between a tangent plane of the vertex of concave curved surface 31 and the horizontal plane is greater than or equal to 0.5β - 15° but less than or equal to 0.5β + 10°, such as 0.5β - 15°, 5β - 10°, 0.5β - 5°, 0.5β, 0.5β + 5°, or 0.5β + 10°. It is ensured that the included angle between the tangent plane of the vertex of the convex surface 221 and the tangent plane of the vertex of the concave curved surface 31 is within a certain range, so as to prevent an excessive included angle from causing large fit difficulty and from increasing the machining difficulty of the concave curved surface 31 or the convex surface 221. For example, an excessive included angle will result in a complicated structure of curved surface when the concave curved surface 31 or the convex surface 221 is an aspherical surface. The above ranges of the included angle β and the included angle γ also ensure a good fit between the lens 22 and the reflector 30 to achieve an optimal collimation effect.

In other embodiments, the included angle β can also be 45°, and the included angle γ between the tangent plane of the vertex of the concave curved surface 31 and the horizontal plane is equal to 0.5β.

The screen 40 is arranged horizontally, the included angle β between the tangent plane of the vertex of the convex surface 221 and the horizontal plane is 45°, and the included angle γ between the tangent plane of the vertex of the concave curved surface 31 and the horizontal plane is 22.5°. After passing through the plano-convex lens, the central light ray of the beam does not change in propagation direction, namely, the central light ray propagates at 45° to the horizontal plane. An incidence point of the central light ray on the reflector 30 is the vertex of the concave curved surface 31, namely, an incidence angle of the central light ray is 22.5°. That is to say, after the central light ray is reflected, the angle will deflect by 45°, and the central light ray becomes a perpendicular light ray to be projected into the screen 40. The included angles between the tangent planes of the points from the vertex to the periphery of the concave curved surface 31 and the horizontal plane change gradually, which is so structurally embodied that an arc surface is between gradually bending upwardly from the vertex to the periphery. For example, included angles between intermediate light rays located between the central light ray and the edge light rays in the beam and the horizontal plane are 30° when the intermediate light rays are emitted from the point light source, and after being refracted by the lens 22, an included angle between the refracted light and the horizontal plane is 40°. The reflection points of the light rays on the reflector 30 are different from the vertex, included angles between the tangent planes of the reflection points and the horizontal plane are 25°, and incidence angles of the intermediate light rays are 25°; namely, the angles of the intermediate light rays will deflect by 50° after they are reflected, and the intermediate light rays forming the included angle of 40° with the horizontal plane become perpendicular light rays projected into the screen 40.

It can be understood that the included angles between the tangent planes of the points on the concave curved surface 31 and the horizontal plane do not need to be set one by one. For example, when the concave curved surface 31 is an aspherical surface, by adjusting parameters of the aspherical surface, such as a radius of curvature R or an aspheric coefficient, the concave curved surface 31 can collimate the light rays to reach such an effect that most of the light rays are collimated or projected into the screen 40 with smaller angle deviations.

In an embodiment, as shown in FIG. 7, the light-emitting element 21 includes a light source 11. The light source 11 can be a point light source or the above-mentioned surface light source, the central light ray of the light source 11 coincides with the optical axis of the lens 22, and a distance a between a central point of the light source 11 and the vertex of the convex surface 221 is greater than or equal to 5 mm but less than or equal to 100 mm, such as 5 mm, 15 mm, 30 mm, 50 mm, 80 mm, or 100 mm. A distance b between the vertex of the convex surface 221 and the vertex of the concave curved surface 31 is greater than or equal to 4a but less than or equal to 30a, such as 4a, 6a, 15a, 20a, or 30a.

When the light source 11 is a point light source, the central light ray of the above-mentioned light source 11 is the central light ray of the beam emitted by the point light source, and the central point of the above-mentioned light source 11 is the point light source; and when the light source 11 is a surface light source, the central light ray of the above-mentioned light source 11 is a central light ray of a beam emitted by the surface light source as a whole, or can be understood as a central light ray of a beam emitted by a central point on the surface light source, and the central point of the above-mentioned light source 11 is a central light-emitting point on the surface light source. In some embodiments, since the light source 11 has a thickness, the central point of the light source 11 can refer to the central point of the top end of the light source 11, namely, the central point of an end face of the light source 11 close to the lens 22. For example, the central light-emitting point of the surface light source close to the vertex of the lens 22 serves as the central point of the light source 11. Taking an example in which the lens 22 is a plano-convex lens and the light source 11 is a UV lamp bead, the center of the UV lamp bead is arranged opposite the optical center of the plano-convex lens, the distance a is the sum of the central thickness of the plano-convex lens and a distance from a central point of the top surface of the UV lamp bead close to the lens 22 to the central point of a planar surface of the plano-convex lens, and the distance a is greater than or equal to 5 mm, so as to ensure that there is a sufficient distance between the UV lamp bead and the planar surface of the plano-convex lens to make the UV lamp bead close to a focal point of the plano-convex lens, and to ensure that the plano-convex lens has a sufficient thickness, thus ensuring effective refraction of the light rays. The distance a is less than or equal to 100 mm, so as to prevent the too long propagation length of the light rays in the plano-convex lens from causing the reduction in light intensity. The distance b is greater than or equal to 4a, so as to avoid the mutual interference between the reflected light and the light rays of the light source assembly 20, and the distance b is less than or equal to 30a, so as to prevent the too long propagation length of the light rays from causing the reduction in light intensity, and to decrease the space occupied by the light source assembly 20. In some embodiments, the light source 11 includes the chip substrate 211, the light-emitting chip 212, and the chip base 213 in other embodiments described above.

In some embodiments, the convex surface 221 and the concave curved surface 31 may be both spherical surfaces, or at least one of the convex surface 221 and the concave curved surface 31 may be an aspherical surface. The aspherical surface refers to a cambered surface having different curvatures continuously changing from the vertex to the edge of the aspherical surface, the surface form of the aspherical surface may be represented by a high-order polynomial containing a coefficient of the aspherical surface, and the aspherical surface may be specifically of a rotationally symmetric structure. In some implementations, the surface form of the aspherical surface is represented by a polynomial as follows:

$$\begin{matrix}z = \frac{{c}_{x} {x}^{2} + {c}_{y} {y}^{2}}{1 + \sqrt{1 - \left(1 + {k}_{x}\right) {C}_{x}^{2} {x}^{2} - \left(1 + {k}_{y}\right) {C}_{y}^{2} {y}^{2}}} + \\ {\sum }_{n = 2}^{10} {A}_{2 n} {\left[\left(1 - {B}_{2 n}\right) {x}^{2} + \left(1 + {B}_{2 n}\right) {y}^{2}\right]}^{n}\end{matrix}$$

wherein z represents a vector height at a point (x, y) on the aspherical surface,

$${c}_{x} = \frac{1}{{R}_{x}} , {c}_{y} = \frac{1}{{R}_{y}} , {c}_{x}$$

represents a curvature of the vertex of the aspherical surface in the x direction, Rₓ represents a radius of curvature of the vertex of the aspherical surface in the x direction, c_{y} represents a curvature of the vertex of the aspherical surface in the y direction, R_{y} represents the radius of curvature of the vertex of the aspherical surface in the y direction, kₓ represents an aspheric coefficient in the x direction, k_{y} represents an aspheric coefficient in the y direction, and A₂ₙ and B₂ₙ are both high-order aspheric coefficients or aspheric correction coefficients; absolute values of A2n and B2n are in the ranges of 0 ≤ A2n < 1 and 0 ≤ B2n < 1, where n is a positive integer greater than 1, such as n = 2, 3, 4...; and the accurate values of the specific parameters are adjusted according to corresponding scenarios, which will not be described in detail herein.

The surfaceprofile of the aspherical surface can be adjusted by adjusting the radius of curvature Rₓ of the vertex of the aspherical surface in the x direction, the radius of curvature R_{y} of the vertex of the aspherical surface in the y direction, the aspheric coefficient kₓ in the x direction and the aspheric coefficient k_{y} in the y direction described above, and thus the adjustment of the uniformization and collimation effects of the light rays is achieved.

The radius of curvature is used for describing the curvature degree of a curved surface, and it can be approximatively understood that the greater the radius of curvature is, the smaller the curvature degree of the curved surface is. The radius of curvature of the vertex of the aspherical surface is a main parameter determining the imaging of an aspherical optical system, and affects basic properties of the aspherical surface, such as a focal length of the aspherical surface, and the best optical effect of the aspherical surface can be achieved by adjusting the radius of curvature of the vertex of the aspherical surface. In an embodiment, the concave curved surface 31 is an aspherical surface, and the radius of curvature R_{X} and the radius of curvature R_{y} of the vertex of the aspherical surface are both greater than or equal to 0.1b but less than or equal to 40b (for example, 0.1b, 5b, 10b, 30b, or 40b), so that the distance between the focal point of the concave curved surface 31 and the vertex is moderate, ensuring that the vertexes of the refracted light rays emitted by the lens 22 are close to the focal point of the concave curved surface 31 or coincides with the focal point of the concave curved surface 31, and ensuring effective collimation of the refracted light rays by the concave curved surface 31. The vertexes of the refracted light rays are in extension lines made by the refracted light rays in the directions opposite to the propagation directions of the light rays, and focal points of the extension lines of all the refracted light rays are the vertexes of the refracted light rays. It can be understood that the vertexes of the refracted light rays are virtual points rather than actual light-emitting points.

The aspheric coefficient may also be referred to as a conic constant or a quadratic curve coefficient. In some embodiments, the aspheric coefficient k = -e², e represents an eccentricity, when kₓ = k_{y} = 0, the cambered surface is a spherical surface, and when kₓ and k_{y} gradually decrease from 0, the surface profile of the curved surface will gradually approach to a planar surface and become an approximately flat ellipsoid, and when kₓ and k_{y} gradually increase from 0, the edge of the cambered surface gradually curls inwardly. It can be approximately understood that the aspheric coefficient affects the curvature degree of the curved surface, that the radius of curvature gradually increases when kₓ and k_{y} gradually decrease from 0, and that the radius of curvature gradually decreases when kₓ and k_{y} gradually increases from 0. In this embodiment, the aspheric coefficient kₓ in the x direction and the aspheric coefficient k_{y} in the y direction are both greater than or equal to -50, so that the concave curved surface has the sufficient effect of converging a beam and can effectively collimate the beam; the aspheric coefficient kₓ in the x direction and the aspheric coefficient k_{y} in the y direction are both less than or equal to 50, so that the aperture of the reflector 30 is not too small, an extension range of the reflecting surface is sufficient to ensure that the reflected light corresponding to any point light source has a sufficient projection area; and the fact that the aspheric coefficient kₓ in the x direction and the aspheric coefficient k_{y} in the y direction are both greater than or equal to -50 but less than or equal to 50 (such as -50, -20, 0, 20, 40, or 50) makes the reflector 30 and the lens 22 sized appropriately for convenience of manufacturing, ensuring that the light source assembly 20 can be conveniently arranged inside the base case without occupying an excessive space.

The lens 22 can be various in structure, and the positions of the lens 22 and the light-emitting element 21 can also be provided in various manners depending on the structure of the lens 22. Three specific structures are exemplified in this embodiment, and the lens 22 is not limited to the following structures:

Firstly, as shown in FIG. 12, the bottom surface 222 is a planar surface, namely, the lens 22 includes a planar surface and an arc-shaped surface facing away from each other. The lens 22 can be embodied as a plano-convex lens. The light-emitting point of the light-emitting element 21 can correspond to the center of the bottom surface 222 of the lens 22, namely, to the optical center of the plano-convex lens.

Secondly, as shown in FIG. 13, the bottom surface 222 is an arc-shaped surface. The bottom surface 222 can be a spherical surface or an aspherical surface, and flexible adjustment on the light refraction effect of the lens 22 can be achieved by adjusting the surface profile of the bottom surface 222 and the cooperation thereof with the convex surface 221, and can be achieved by further processing an existing plano-convex lens to reduce the production cost. The bottom surface 222 can be an arc-shaped surface that is recessed in the direction of the convex surface 221, namely, the lens 22 is a meniscus lens. Alternatively, the bottom surface 222 can be an arc-shaped surface that protrudes in the opposite direction of the convex surface 221, namely, the lens 22 is a lenticular lens.

Thirdly, as shown in FIG. 14, the lens 22 includes a recess 223, and the light-emitting element 21 includes the light source 11, and can also include the substrate 23 mentioned in the other embodiments above. The substrate 23 is arranged at an opening of the recess 223, the substrate 23 and the recess 223 define a cavity, and the light source 11 is arranged on the substrate 23 and located in the cavity.

Since the light source 11 is located closer to the screen 40 and has the highest light intensity, the light source 11 is arranged in the cavity so that the light rays from the light source 11 do not affect the screen 40, and the beam of the light source 11 is less likely to be affected by the external environment.

In an embodiment, as shown in FIG. 14, the lens 22 further includes a first planar surface 224. The first planar surface 224 is connected to an edge of the convex surface 221 and circumferentially surrounds the convex surface 221. The bottom surface 222 includes a central planar surface 2231, a conical surface 2232 and a second planar surface 225. The conical surface 2232 circumferentially surrounds the central planar surface 2231, and the second planar surface 225 circumferentially surrounds the conical surface 2232. In some embodiments, the central planar surface 2231 is closer to the convex surface 221 than the conical surface 2232. The light rays emitted by the light source 11 are emitted into the lens 22 through the central planar surface 2231 and the conical surface 2232 respectively.

Taking the vertical downward orientation of the opening of the recess 223 in FIG. 14 as an example, the lens 22 between the convex surface 221 and the recess 223 is a solid transparent region, an annular boss is provided at an outer periphery of the lens region, the top surface of the annular boss is the first planar surface 224, the second planar surface 225 at the outer periphery of the opening of the recess 223 is a bottom surface of the annular boss, and the annular boss is used for connection with a fixing device to fix the lens 22 and for connection with the substrate 23. In addition to the connection function, the first planar surface 224 also has the function of filtering stray light. For example, the first planar surface 224 is covered by a light-blocking layer, and the first planar surface 224 is also configured to block part of large-angle light rays. When the beam of the light source 11 is relatively divergent, including the large-angle stray light rays, the stray light will be guided into the first planar surface 224 after entering the lens 22, and is prevented from affecting the uniformity and collimation of the beam by providing the light-blocking layer on the first planar surface 224, such as a plastic sheet or a metal sheet; and since the first planar surface 224 is lower than the bottom of the recess 223, namely, the above-mentioned central planar surface 2231, most of the light rays can still pass through the lens 22 and form refracted light, without causing the light intensity to be reduced. The oblique arrangement of the conical surface 2232 relative to the central light ray has a strong light converging effect on the light rays entering the lens 22 through the conical surface 2232, so that the light rays close to the edge in the beam are concentrated, the light rays are uniform, and when the lens is applied to a photo-curing printer, the intensity and the uniformity of the light at the edge of the screen can be optimized. In the above example, the lens can also be applied to the lens holder 24 in the other embodiments described above. The lens holder 24 can cover the first surface 233, a receiving cavity 241 can be formed between the lens holder 24 and the first surface 233, and the light-emitting element 21 can be located in the receiving cavity 241 so as to achieve the integrated arrangement of the light-emitting element 21 and the lens 22. The lens holder 24 is made of a light-shielding material, or an inner surface or an outer surface of the lens holder 24 is provided with a light-shielding layer, so as to prevent the light rays emitted by the light-emitting element 21 from being emitted in other directions than in the direction of the lens 22, and to achieve the purpose of improving the light emission effect of the light source assembly 20.

In an embodiment, a perpendicular distance between the central planar surface 2231 and the second planar surface 225 is greater than a perpendicular distance between the first planar surface 224 and the second planar surface 225. Taking the orientation of FIG. 14 as an example, the central planar surface 2231 is higher than the first planar surface 224, so that the blocking of the refracted light rays by the boss is reduced, the lens 22 is allowed to have a larger region for light ray adjustment, a larger amount of light rays can be projected into the screen 40 by passing through the region between the conical surface 2232 and the convex surface 221, uniformization of the light rays by the lens is ensured, and the light ray intensity can be ensured.

The lens 22 is preferably a plano-concave lens that is simple in processing and low in cost, and can be specifically made of a plastic material such as PMMA or PC, or of a glass material such as high borosilicate glass, quartz glass, H-K9 or H-K51.

The reflector 30 can be made of a metal material such as aluminm alloy or stainless steel, the reflector 30 can also be made of a plastic material such as PMMA or PC, or the reflector 30 can be made of a glass material such as high borosilicate glass, quartz glass, H-K9 or H-K51. The metal material can be used for manufacturing a reflecting surface by using its reflection function, or the reflectivity can be enhanced by covering the reflecting surface with a coating including a metal coating such as an aluminm coating or a silver coating, or a coating of another alloy material such as a pure aluminm coating and/or a vacuum coating. For example, the reflectivity is greater than or equal to 70% to ensure the light intensity of the projected light. In this embodiment, the reflectivity is 90% to reduce the loss of the light rays and ensure the light intensity.

In some embodiments, the thickness of the coating is greater than or equal to 100 nm to ensure the reflection performance of the coating and to make same not liable to disengagement; and the thickness of the coating is less than or equal to 150 nm to avoid the variation of the thickness when the coating is heated, to ensure that the light path distances from the lens 22 to the concave curved surface of the reflector 30, and from the concave curved surface of the reflector 30 to the screen 40 are stable, and to avoid that the projected light rays are affected by thermal expansion of the coating. In an embodiment, the thickness of the coating is 120 nm.

In another aspect, an embodiment of the present invention further provides a printer, including a light source assembly 20 of any one of the above embodiments, and

a screen 40, the screening 40 being configured to display a pattern having a specific contour.

The light source assembly 20 is arranged on one side of the screen 40, and light rays emitted by the light source assembly 20 are uniformly projected into the screen 40 and pass through the screen 40 to cure a printing resin.

The 3D printer further includes a base case, a lifting assembly, a printing platform and a resin vat. The resin vat is configured to contain the printing resin and is placed on the screen 40, the light source assembly 20 is located in the base case, and the lifting assembly is connected to the base case and the printing platform. The screen 40 is connected to a master controller of the 3D printer, the master controller analyzes printing data and divides the printing data into patterns one by one, each pattern can correspond to a shape of each layer of a printing model, the master controller transmits the patterns to the screen 40, projected light from the light source assembly 20 is projected to the screen 40, and the screen 40 enables the projected light having a specific profile to pass and be projected to the printing resin according to the patterns, such that the printing resin is cured to form a layer of model having the same pattern shape. The printing platform drives the model to move upwardly or downwardly, such that the model is separated from the resin vat, and the above process is repeated to print the model layer by layer.

The arrangement position of the light source assembly 20 has direct influence on the light intensity and the light ray quality of the transmitted light. In this embodiment, the distance a between the point light source 12 and the vertex of the convex surface 221 is greater than or equal to 5 mm but less than or equal to 100 mm. The distance b between the vertex of the convex surface 221 and the vertex of the concave curved surface 31 is greater than or equal to 4a but less than or equal to 30a, and the perpendicular distance c between the vertex of the concave curved surface 31 of the reflector 30 and the surface of the screen on the side facing away from the light source assembly 20 is greater than or equal to 0.5b but less than or equal to 2b. The above-mentioned distance a, distance b and perpendicular distance c are correlated with each other in turn, so that the position of the reflector 30 is restricted by the relative position of the point light source 12 and the lens 22. The distance c is greater than or equal to 0.5b, so that the projected light is not affected by the light rays of the point light source 12, and a sufficient space is provided for the lens 22. The distance c is less than or equal to 2b, so that a high light intensity can be ensured, and an optimal projection effect is thus achieved. In some embodiments, the reflector 30 can be fixed to the fixing seat 70 in other embodiments described above to better adjust the reflector 30. In some embodiments, the screen 40 can be arranged on the fixing plate 80 in other embodiments described above.

It will be appreciated that the distance ranges (parameters) illustrated above do not present separately, but are mutually restrictive to jointly enable the adjustment of the propagation angles of the light rays, so that the refracted light shows good uniformity and collimation. The light source assembly 20 is a complex organic optical system, and the functions of uniformity and collimation are achieved by mutual restriction of a plurality of parameters, and the range of a parameter is not obtained by testing the single parameter, but by cross-testing a plurality of parameter value ranges. For example, provided that the distance a has a value of 5 mm, the optimal distance range is obtained by performing multiple tests on the distance between the vertex of the convex surface 221 and the vertex of the concave curved surface 31, and provided that the distance a has a value of 6 mm, by similarly and repeatedly performing multiple tests on the distance between the vertex of the convex surface 221 and the vertex of the concave curved surface 31. A plurality of sets of range data corresponding to the distance a between the vertex of the convex surface 221 and the vertex of the concave curved surface 31 having different values are finally obtained; the rule of the range data is then summarized to obtain a range value having a certain universality, namely, the distance b between the vertex of the convex surface 221 and the vertex of the concave curved surface 31 is greater than or equal to 4a but less than or equal to 30a, and within this range of values, good uniformization and collimation effects can be achieved, and accordingly a guiding role can be played. Similarly, for example, the value ranges of the angles such as the included angle β between the tangent plane of the vertex of the convex surface and the horizontal plane and the included angle γ between the tangent plane of the vertex of the concave curved surface and the horizontal plane, and the mutual restrictive relationship are sequentially tested by using various combinations, and finally the restrictive relationship is obtained. For example, the included angle γ is greater than or equal to 0.5β - 15° but less than or equal to 0.5β + 10°.

In an aspect, embodiments of the present invention provide:

1. A light source assembly 20 for a printer, the light source assembly including:
a light-emitting element 21, a lens 22 and a reflector 30, wherein
the light-emitting element 21 and the reflector 30 are arranged on two opposite sides of the lens 22; and
the reflector 30 cooperates with the lens 22 such that light rays emitted by the light-emitting element 21 are projected after being refracted by the lens 22 and reflected by the reflector 30.

2. The light source assembly 20 according to Embodiment 1, wherein the lens 22 includes a convex surface 221 and a bottom surface 222 facing away from each other, the reflector 30 includes a concave curved surface 31, the light-emitting element 21 is arranged corresponding to the bottom surface 222, and the concave curved surface 31 is arranged corresponding to the convex surface 221; and

the light rays are refracted by the convex surface 221 and the bottom surface 222, and the light rays are reflected by the concave curved surface 31.

3. The light source assembly 20 according to Embodiment 2, wherein an included angle β between a tangent plane of a vertex of the convex surface 221 and a horizontal plane is greater than or equal to 30° but less than 45°;
or the angle β between the tangent plane of the vertex of the convex surface 221 and the horizontal plane is greater than 45° but less than or equal to 90°;
or the included angle β between the tangent plane of the vertex of the convex surface 221 and the horizontal plane is equal to 45°.

4. The light source assembly 20 according to Embodiment 2, wherein the included angle between the tangent plane of the vertex of the convex surface 221 and the horizontal plane is β, and an included angle γ between a tangent plane of the vertex of the concave curved surface 31 and the horizontal plane is greater than or equal to 0.5β - 15° but less than or equal to 0.5β + 10°.

5. The light source assembly 20 according to Embodiment 2, wherein the included angle between the tangent plane of the vertex of the convex surface 221 and the horizontal plane is represented by β, and the included angle γ between the tangent plane of the vertex of the concave curved surface 31 and the horizontal plane is equal to 0.5β.

6. The light source assembly 20 according to Embodiment 2, wherein the light-emitting element 21 includes a light source 11, and a central light ray of the light source 11 coincides with an optical axis of the lens 22;
a distance a between a central point of the light source 11 and the vertex of the convex surface 221 is greater than or equal to 5 mm but less than or equal to 100 mm; and
a distance b between the vertex of the convex surface 221 and the vertex of the concave curved surface 31 is greater than or equal to 4a but less than or equal to 30a.

7. The light source assembly 20 according to Embodiment 6, wherein the light source 11 is a point light source;

or the light source 11 is an area light source including a plurality of light-emitting chips, a distance between two adjacent light-emitting chips being less than or equal to a threshold.

8. The light source assembly 20 according to Embodiment 6, wherein the light source 11 is a surface light source including a plurality of light-emitting chips, a distance between two adjacent light-emitting chips being less than or equal to 3 mm.

9. The light source assembly 20 according to Embodiment 2, wherein the convex surface 221 and the concave curved surface 31 are both spherical surfaces;

or at least one of the convex surface 221 and the concave curved surface 31 is an aspherical surface.

10. The light source assembly 20 according to Embodiment 2, wherein

at least one of the convex surface and the concave curved surface is an aspherical surface meeting the following equation:

$$\begin{matrix}z = \frac{{c}_{x} {x}^{2} + {c}_{y} {y}^{2}}{1 + \sqrt{1 - \left(1 + {k}_{x}\right) {C}_{x}^{2} {x}^{2} - \left(1 + {k}_{y}\right) {C}_{y}^{2} {y}^{2}}} + \\ {\sum }_{n = 2}^{10} {A}_{2 n} {\left[\left(1 - {B}_{2 n}\right) {x}^{2} + \left(1 + {B}_{2 n}\right) {y}^{2}\right]}^{n}\end{matrix}$$

wherein z represents a vector height at a point (x, y) on the aspherical surface,

$${c}_{x} = \frac{1}{{R}_{x}} , {c}_{y} = \frac{1}{{R}_{y}} , {c}_{x}$$

represents a curvature of the vertex of the aspherical surface in the x direction, Rₓ represents a radius of curvature of the vertex of the aspherical surface in the x direction, c_{y} represents a curvature of the vertex of the aspherical surface in the y direction, R_{y} represents the radius of curvature of the vertex of the aspherical surface in the y direction, kₓ represents an aspheric coefficient in the x direction, k_{y} represents an aspheric coefficient in the y direction, and A₂ₙ and B₂ₙ are both high-order aspheric coefficients or aspheric correction coefficients, where n is a positive integer greater than 1.

11. The light source assembly 20 according to Embodiment 2, wherein the concave curved surface 31 is an aspherical surface having a radius of curvature R greater than or equal to 0.1b but less than or equal to 40b and an aspheric coefficient k greater than or equal to -50 but less than or equal to 50.

12. The light source assembly 20 according to Embodiment 2, wherein the bottom surface 222 is a planar surface;
or the bottom surface 222 is an arc-shaped surface;
or the lens 22 includes a recess 223, and the light-emitting element 21 includes the light source 11 and a substrate 23, wherein the substrate 23 is arranged at an opening of the recess 223, the substrate 23 and the recess 223 define a cavity, and the light source 11 is arranged on the substrate 23 and is located in the cavity.

13. The light source assembly 20 according to Embodiment 2, wherein the lens 22 further includes a first planar surface 224, the first planar surface 224 being connected to an edge of the convex surface 221 and circumferentially surrounding the convex surface 221; the bottom surface 222 includes a central planar surface 2231, a conical surface 2232 and a second planar surface 225, the conical surface 2232 circumferentially surrounding the central planar surface 2231, and the second planar surface 225 circumferentially surrounding the conical surface 2232; and

light rays emitted by the light source 11 enter the lens 22 through the central planar surface 2231 and the conical surface 2232 respectively.

14. The light source assembly 20 according to Embodiment 13, wherein a perpendicular distance between the central planar surface 2231 and the second planar surface 225 is greater than a perpendicular distance between the first planar surface 224 and the second planar surface 225.

15. The light source assembly 20 according to Embodiment 13, wherein the first planar surface 224 is covered by a light-blocking layer, and the first planar surface 224 is configured to block the light rays.

16. The light source assembly 20 according to Embodiment 2, wherein the concave curved surface 31 is covered by a coating configured to reflect the light rays.

17. The light source assembly 20 according to Embodiment 16, wherein the coating has a thickness greater than or equal to 100 nm but less than or equal to 150 nm.

18. The light source assembly 20 according to Embodiment 16, wherein the coating includes a pure aluminm coating and/or a vacuum coating.

19. The light source assembly 20 according to Embodiment 16, wherein the concave curved surface 31 has a reflectivity greater than or equal to 70%.

20. The light source assembly 20 according to Embodiment 1, wherein

the light rays are uniformly projected after being refracted by a light-transmitting assembly.

21. The light source assembly 20 according to Embodiment 1, wherein

the light rays are collimated and projected after being reflected by the reflector.

In another aspect, embodiments of the present invention further provide:

22. A printer, including: a light source assembly 20 of any one of the above embodiments, and
a screen 40, the screening 40 being configured to display a pattern having a specific contour, wherein
the light source assembly 20 is arranged on one side of the screen 40, and light rays emitted by the light source assembly 20 are uniformly projected into the screen 40 and pass through the screen 40 to cure a printing resin.

23. The printer according to Embodiment 22, wherein a perpendicular distance c between the vertex of the concave curved surface 31 of the reflector 30 and the surface of the screen 40 on the side facing away from the light source assembly 20 is greater than or equal to 0.5b but less than or equal to 2b, where b represents a distance between the vertex of the convex surface 221 of the lens 22 and the vertex of the concave curved surface 31 of the reflector 30.

The foregoing description merely relates to the specific embodiments of the present invention, but the scope of protection of the present invention is not limited thereto. Any changes or replacements that can be easily conceived by those skilled in the art within the technical scope disclosed by the present invention shall fall within the scope of protection of the present invention. Therefore, the scope of protection of the present invention shall be subject to the scope of protection of the claims.

What is claimed is:

1. A light source assembly for a printer, comprising: a light-emitting element, a lens and a reflector, wherein
the light-emitting element and the reflector are arranged on two opposite sides of the lens; and
the reflector cooperates with the lens such that light rays emitted by the light-emitting element are projected after being refracted by the lens and reflected by the reflector.

2. The light source assembly according to claim 1, wherein
the lens comprises a convex surface and a bottom surface, the convex surface and the bottom surface are facing away from each other, the reflector comprises a concave curved surface, the light-emitting element is arranged corresponding to the bottom surface, and the concave curved surface is arranged corresponding to the convex surface; and
the light rays are refracted by the convex surface and the bottom surface, and the light rays are reflected by the concave curved surface.

3. The light source assembly according to claim 2, wherein
the convex surface and the concave curved surface are spherical surfaces, or at least one of the convex surface and the concave curved surface is an aspherical surface, or the concave curved surface is an aspherical surface, a radius of curvature R of the aspherical surface is greater than or equal to 0.1b but less than or equal to 40b, an aspheric coefficient k of the aspherical surface is greater than or equal to -50 but less than or equal to 50, wherein b represents a distance between a vertex of the convex surface and a vertex of the concave curved surface;
an included angle β between a tangent plane of the vertex of the convex surface and a horizontal plane is greater than or equal to 30° but less than 45°, or the included angle β between the tangent plane of the vertex of the convex surface and the horizontal plane is greater than 45° but less than 90°, or the included angle β between the tangent plane of the vertex of the convex surface and the horizontal plane is equal to 45°;
or the included angle between the tangent plane of the vertex of the convex surface and the horizontal plane is β, and an included angle y between a tangent plane of the vertex of the concave curved surface and the horizontal plane is greater than or equal to 0.5β - 15° but less than or equal to 0.5β + 10°, or the included angle between the tangent plane of the vertex of the convex surface and the horizontal plane is β, and the included angle γ between the tangent plane of the vertex of the concave curved surface and the horizontal plane is equal to 0.5β.

4. The light source assembly according to claim 2, wherein
the light-emitting element comprises a light source, wherein a central light ray of the light source coincides with an optical axis of the lens;
a distance a between a central point of the light source and a vertex of the convex surface is greater than or equal to 5 mm but less than or equal to 100 mm;
a distance b between the vertex of the convex surface and a vertex of the concave curved surface is greater than or equal to 4a but less than or equal to 30a; and
a reflectivity of the concave curved surface is greater than or equal to 70%.

5. The light source assembly according to claim 4, wherein
the light source is a point light source;
or the light source is a surface light source comprising a plurality of light-emitting chips, with a distance between two adjacent light-emitting chips being less than or equal to a threshold.

6. The light source assembly according to claim 2, wherein
at least one of the convex surface and the concave curved surface is an aspherical surface meeting the following equation:
$$\begin{matrix}z = \frac{{c}_{x} {x}^{2} + {c}_{y} {y}^{2}}{1 + \sqrt{1 - \left(1 + {k}_{x}\right) {C}_{x}^{2} {x}^{2} - \left(1 + {k}_{y}\right) {C}_{y}^{2} {y}^{2}}} + \\ {\sum }_{n = 2}^{10} {A}_{2 n} {\left[\left(1 - {B}_{2 n}\right) {x}^{2} + \left(1 + {B}_{2 n}\right) {y}^{2}\right]}^{n}\end{matrix}$$
wherein z represents a vector height at a point (x, y) on the aspherical surface,
$${c}_{x} = \frac{1}{{R}_{x}} , {c}_{y} = \frac{1}{{R}_{y}} ,$$
cₓ represents a curvature of a vertex of the aspherical surface in an x direction, Rₓ represents a radius of curvature of the vertex of the aspherical surface in the x direction, c_{y} represents a curvature of the vertex of the aspherical surface in a y direction, R_{y} represents a radius of curvature of the vertex of the aspherical surface in the y direction, kₓ represents an aspheric coefficient in the x direction, k_{y} represents an aspheric coefficient in the y direction, and A₂ₙ and B₂ₙ are high-order aspheric coefficients or aspheric correction coefficients, wherein n is a positive integer greater than 1.

7. The light source assembly according to claim 2, wherein
the bottom surface is a planar surface;
or the bottom surface is an arc-shaped surface;
or the lens comprises a recess, and the light-emitting element comprises a light source and a substrate, wherein the substrate is arranged at an opening of the recess, the substrate and the recess define a cavity, and the light source is arranged on the substrate and is located in the cavity.

8. The light source assembly according to claim 2, wherein
the lens further comprises a first planar surface, wherein the first planar surface is connected to an edge of the convex surface and circumferentially surrounds the convex surface;
the bottom surface comprises a central planar surface, a conical surface and a second planar surface, wherein the conical surface circumferentially surrounds the central planar surface, and the second planar surface circumferentially surrounds the conical surface; and
the central planar surface and the conical surface are respectively configured to receive light rays emitted by a light source, and configured to transmit light rays to the lens .

9. The light source assembly according to claim 8, wherein
a perpendicular distance between the central planar surface and the second planar surface is greater than a perpendicular distance between the first planar surface and the second planar surface; and
the first planar surface is covered by a light-blocking layer, and the first planar surface is configured to block the light rays.

10. The light source assembly according to claim 1, further comprising a lens holder and a substrate, wherein the substrate comprises a first surface;
wherein the lens is arranged on the first surface by the lens holder, the light-emitting element is arranged on the first surface and is located between the lens and the first surface, a receiving cavity is formed between the lens holder and the first surface, the light-emitting element is located in the receiving cavity; and
the lens holder is made of a light-shielding material, or the lens holder is provided with a light-shielding layer.

11. A printer, comprising:
the light source assembly of claim 1, and
a screen for displaying a pattern having a specific contour;
wherein the light source assembly is arranged on a first side of the screen, and light rays emitted from the light source assembly are uniformly projected into the screen and pass through the screen to cure a printing resin.

12. The printer according to claim 11, wherein
a perpendicular distance c between a vertex of a concave curved surface of the reflector and a surface of a second side of the screen is greater than or equal to 0.5b but less than or equal to 2b, wherein the second side of the screen faces away from the light source assembly, b represents a distance between a vertex of a convex surface of the lens and the vertex of the concave curved surface of the reflector.

13. The printer according to claim 11, wherein in the light source assembly,
the lens comprises a convex surface and a bottom surface facing away from each other, the reflector comprises a concave curved surface, the light-emitting element is arranged corresponding to the bottom surface, and the concave curved surface is arranged corresponding to the convex surface; and
the light rays are refracted by the convex surface and the bottom surface, and the light rays are reflected by the concave curved surface.

14. The printer according to claim 13, wherein in the light source assembly,
the convex surface and the concave curved surface are spherical surfaces, or at least one of the convex surface and the concave curved surface is an aspherical surface, or the concave curved surface is an aspherical surface having a radius of curvature R greater than or equal to 0.1b but less than or equal to 40b and an aspheric coefficient k greater than or equal to -50 but less than or equal to 50, wherein b represents a distance between a vertex of the convex surface and a vertex of the concave curved surface;
an included angle β between a tangent plane of the vertex of the convex surface and a horizontal plane is greater than or equal to 30° but less than 45°, or the included angle β between the tangent plane of the vertex of the convex surface and the horizontal plane is greater than 45° but less than 90°, or the included angle β between the tangent plane of the vertex of the convex surface and the horizontal plane is equal to 45°;
or the included angle between the tangent plane of the vertex of the convex surface and the horizontal plane is β, and an included angle y between a tangent plane of the vertex of the concave curved surface and the horizontal plane is greater than or equal to 0.5β - 15° but less than or equal to 0.5β + 10°, or the included angle between the tangent plane of the vertex of the convex surface and the horizontal plane is β, and the included angle y between the tangent plane of the vertex of the concave curved surface and the horizontal plane is equal to 0.5β.

15. The printer according to claim 13, wherein in the light source assembly,
the light-emitting element comprises a light source, wherein a central light ray of the light source coincides with an optical axis of the lens;
a distance a between a central point of the light source and a vertex of the convex surface is greater than or equal to 5 mm but less than or equal to 100 mm;
a distance b between the vertex of the convex surface and a vertex of the concave curved surface is greater than or equal to 4a but less than or equal to 30a; and
the concave curved surface has a reflectivity greater than or equal to 70%.

16. The printer according to claim 15, wherein in the light source assembly,
the light source is a point light source;
or the light source is a surface light source comprising a plurality of light-emitting chips, with a distance between two adjacent light-emitting chips being less than or equal to a threshold.

17. The printer according to claim 13, wherein in the light source assembly,
at least one of the convex surface and the concave curved surface is an aspherical surface meeting the following equation:
$$\begin{matrix}z = \frac{{c}_{x} {x}^{2} + {c}_{y} {y}^{2}}{1 + \sqrt{1 - \left(1 + {k}_{x}\right) {C}_{x}^{2} {x}^{2} - \left(1 + {k}_{y}\right) {C}_{y}^{2} {y}^{2}}} + \\ {\sum }_{n = 2}^{10} {A}_{2 n} {\left[\left(1 - {B}_{2 n}\right) {x}^{2} + \left(1 + {B}_{2 n}\right) {y}^{2}\right]}^{n}\end{matrix}$$
wherein z represents a vector height at a point (x, y) on the aspherical surface,
$${c}_{x} = \frac{1}{{R}_{x}} , {c}_{y} = \frac{1}{{R}_{y}} ,$$
cₓ represents a curvature of a vertex of the aspherical surface in an x direction, Rₓ represents a radius of curvature of the vertex of the aspherical surface in the x direction, c_{y} represents a curvature of the vertex of the aspherical surface in a y direction, R_{y} represents a radius of curvature of the vertex of the aspherical surface in the y direction, kₓ represents an aspheric coefficient in the x direction, k_{y} represents an aspheric coefficient in the y direction, and A₂ₙ and B₂ₙ are high-order aspheric coefficients or aspheric correction coefficients, wherein n is a positive integer greater than 1.

18. The printer according to claim 13, wherein in the light source assembly,
the bottom surface is a planar surface;
or the bottom surface is an arc-shaped surface;
or the lens comprises a recess, and the light-emitting element comprises a light source and a substrate, wherein the substrate is arranged at an opening of the recess, the substrate and the recess define a cavity, and the light source is arranged on the substrate and is located in the cavity.

19. The printer according to claim 13, wherein in the light source assembly,
the lens further comprises a first planar surface, wherein the first planar surface is connected to an edge of the convex surface and circumferentially surrounds the convex surface;
the bottom surface comprises a central planar surface, a conical surface and a second planar surface, wherein the conical surface circumferentially surrounds the central planar surface, and the second planar surface circumferentially surrounds the conical surface; and
light rays emitted by a light source enter the lens through the central planar surface and the conical surface respectively.

20. The printer according to claim 19, wherein in the light source assembly,
a perpendicular distance between the central planar surface and the second planar surface is greater than a perpendicular distance g between the first planar surface and the second planar surface; and
the first planar surface is covered by a light-blocking layer, and the first planar surface is configured to block the light rays.
